(19) United States
(12) Patent Application Publication
(10) Pub. No.: US 2025/0105241 A1
(43) Pub. Date: Mar. 27, 2025

(54) Secondary Battery Electrode Plate and Preparation Method Therefor, and Secondary Battery

(71) Applicant: BYD COMPANY LIMITED, Shenzhen (CN)

(72) Inventors: Huajun Sun, Shenzhen (CN); Xiaotao Yuan, Shenzhen (CN); Kefeng He, Shenzhen (CN); Zhan Xu, Shenzhen (CN); Liping Ge, Shenzhen (CN)

(21) Appl. No.: 18/971,766

(22) Filed: Dec. 6, 2024

Related U.S. Application Data
(63) Continuation of application No. PCT/CN2023/103481, filed on Jun. 28, 2023.

(30) Foreign Application Priority Data
Jun. 29, 2022 (CN) 202210752174.8

(51) Int. Cl. H01M 4/04; H01M 4/02; H01M 4/70; H01M 10/0525

(52) U.S. Cl. CPC H01M 4/0404; H01M 4/0435; H01M 4/70; H01M 10/0525; H01M 2004/021

(57) ABSTRACT

A secondary battery electrode plate and a preparation method therefor, and a secondary battery are provided. The secondary battery electrode plate includes a current collector and a first active material layer. The first active material layer is located on a surface of the current collector and contains first active substance particles The first active substance particles have an equivalent sphericity X₁ as represented by formula X₁=3/(S₁R₁ρ₁), where 0.05≤X₁≤0.8; R₁ is a median radius of the first active substance particles in a unit of μm; S₁ is a specific surface area of the first active substance particles in a unit of m²/g; and ρ₁ is true density of the first active substance particles in a unit of g/cm³.

### CROSS-REFERENCE TO RELATED APPLICATIONS

The present disclosure claims priority to Chinese Patent Application No. CN202210752174.8, filed on Jun. 29, 2022. The entire content of the above-referenced application is incorporated herein by reference.

### FIELD

The present disclosure relates to the field of lithium ion batteries, and more specifically, to a secondary battery electrode plate and a preparation method therefor, and a secondary battery.

### BACKGROUND

The increase of the thickness of an electrode can improve the energy density of a battery core and reduce costs of the battery core. However, with the increase of the thickness, diffusion paths of lithium ions in the electrode become longer, the liquid phase diffusion impedance of the electrode is increased, and electrode reaction kinetics are reduced. To improve the kinetic performance of a thick electrode, electrode compaction is often reduced, or the content of a conductive agent in the electrode is increased. The former reduces the energy density of the electrode, and the later often reduces the capacity per gram of a mixture of the electrode and further increases the costs.

To ensure both the energy density and the kinetic performance of the electrode, an important research direction is to reduce the tortuosity of an active material layer inside the electrode. There are many methods for reducing the tortuosity of the electrode, for example, increasing porosity, constructing a vertical pore structure of the electrode, and changing material particle morphology. However, the foregoing methods still cannot achieve an excellent effect of reducing the tortuosity of the active material layer inside the electrode.

### SUMMARY

The present disclosure provides a secondary battery electrode plate and a preparation method therefor, and a secondary battery. The compaction of an electrode of the secondary battery electrode plate is ensured, and the electrode has a high capacity retention rate and liquid phase diffusion impedance of the electrode is reduced.

In a first aspect of the present disclosure, a secondary battery electrode plate is provided. The secondary battery electrode plate includes a current collector and a first active material layer. The first active material layer is located on a surface of the current collector. The first active material layer contains first active substance particles. The first active substance particles have an equivalent sphericity X₁ as represented by the following Formula (1):

$${X}_{1} = 3 / ( {S}_{1} {R}_{1} {ρ}_{1} ) , \qquad Formula ( 1 )$$

where 0.05≤X₁≤0.8, R₁ is a median radius of the first active substance particles in a unit of μm; S₁ is a specific surface area of the first active substance particles in a unit of m²/g; and ρ₁ is true density of the first active substance particles in a unit of g/cm³.

In some embodiments, when the electrode plate is a positive electrode plate, 0.10≤X₁≤0.8; or when the electrode plate is a negative electrode plate, 0.05≤X₁≤0.8.

In some embodiments, the secondary battery electrode plate further includes a second active material layer; the second active material layer is located on a surface, deviating from the surface of the current collector, of the first active material layer; the second active material layer contains second active substance particles; the second active substance particles have an equivalent sphericity X₂ as represented by the following Formula (2):

$${X}_{2} = 3 / ( {S}_{2} {R}_{2} {ρ}_{2} ) , \qquad Formula ( 2 )$$

where R₂ is a median radius of the second active substance particles in the unit of μm; S₂ is a specific surface area of the second active substance particles in the unit of m²/g; ρ₂ is true density of the second active substance particles in the unit of g/cm³; and the sphericity X₂ of the second active substance particles is greater than the equivalent sphericity X₁ of the first active substance particles.

In some embodiments, 0.05≤X₁≤0.4; and 0.2≤X₂≤0.8.

In some embodiments, 0.1≤X₁≤0.3; and 0.2≤X₂≤0.5.

In some embodiments, 0.07≤X₂−X₁≤0.5.

In some embodiments, 0.2≤X₂−X₁≤0.4.

In some embodiments, when the electrode plate is a positive electrode plate, R₁ and R₂ of the first active substance particles are respectively and independently any values ranging from 0.05 to 5, and S₁ and S₂ are respectively and independently any values ranging from 0.5 to 20.

When the electrode plate is a negative electrode plate, R₁ and R₂ of the first active substance particles are respectively and independently any values ranging from 1 to 20, and S₁ and S₂ are respectively and independently any values ranging from 0.5 to 5.

In some embodiments, surface density of the first active material layer is Y₁=ε×L, and surface density of the second active material layer is Y₂=(1−ε)×L,
where L is total surface density of the first active material layer and the second active material layer in the unit of g/m², one side of the current collector is coated with the first active material layer, or each of two sides of the current collector is coated with the first active material layer, and the surface, deviating from the current collector, of each first active material layer is coated with the second active material layer.

If one side of the current collector is coated with the first active material layer, when the electrode plate is the positive electrode plate, 50≤L≤300, or when the electrode plate is the negative electrode plate, 23≤L≤138.

If each of the two sides of the current collector is coated with the first active material layer, when the electrode plate is the negative electrode plate, 100≤L≤600, or when the electrode plate is the negative electrode plate, 46≤L≤276; and c is an adjustment parameter, and 0.2≤ε≤0.8.

In some embodiments, 0.1≤(X₂/Y₂)/(X₁/Y₁)≤6.

In some embodiments, 0.25≤(X₂/Y₂)/(X₁/Y₁)≤4.5.

In some embodiments, when the electrode plate is the positive electrode plate, compacted density is 2.0 to 2.7 g/cm³; or when the electrode plate is the negative electrode plate, compacted density is 1.0 to 2.0 g/cm³.

In a second aspect of the present disclosure, a method for preparing a secondary battery electrode plate is provided. The method includes the following steps:
Step S1, coating a current collector with first slurry to obtain an electrode plate with the current collector coated with a first slurry layer; and
Step S2, rolling the electrode plate.

The first slurry contains first active substance particles, and the first active substance particles have an equivalent sphericity X₁ as represented by the following Formula (1):

$${X}_{1} = 3 / ( {S}_{1} {R}_{1} {ρ}_{1} ) , \qquad Formula ( 1 )$$

where 0.05≤X₁≤0.8, R₁ is a median radius of the first active substance particles in a unit of μm; S₁ is a specific surface area of the first active substance particles in a unit of m²/g; and ρ₁ is true density of the first active substance particles in a unit of g/cm³.

In some embodiments, when the electrode plate is a positive electrode plate, 0.10≤X₁≤0.8; or when the electrode plate is a negative electrode plate, 0.05≤X₁≤0.8.

In some embodiments, step S1 includes: coating the current collector with the first slurry and second slurry to obtain an electrode plate sequentially coated with the first slurry layer and the second slurry layer in a direction far away from the current collector.

The second slurry contains second active substance particles, and the second active substance particles have an equivalent sphericity X₂ as represented by the following Formula (2):

$${X}_{2} = 3 / ( {S}_{2} {R}_{2} {ρ}_{2} ) , \qquad Formula ( 2 )$$

where R₂ is a median radius of the second active substance particles in the unit of μm; S₂ is a specific surface area of the second active substance particles in the unit of m²/g; ρ₂ is true density of the second active substance particles in the unit of g/cm³; and the sphericity X₂ of the second active substance particles is greater than the equivalent sphericity X₁ of the first active substance particles.

In a third aspect of the present disclosure, a secondary battery is provided. The secondary battery includes the secondary battery electrode plate according to the first aspect of the present disclosure.

As described herein, the first active material layer of the secondary battery electrode plate provided by the present disclosure uses active substance particles with sphericity, which can reduce the liquid phase impedance of the electrode and improve the capacity retention rate while ensuring that the electrode has high compacted density.

Other features and advantages of the present disclosure will be described in detail in the following detailed description.

### DETAILED DESCRIPTION

Embodiments of the present disclosure are described in detail below. It is to be noted that the specific embodiments described herein are merely used to describe and explain the present disclosure, but are not intended to limit the present disclosure.

A first aspect of the present disclosure provides a secondary battery electrode plate. The secondary battery electrode plate includes a current collector and a first active material layer. The first active material layer is located on a surface of the current collector. The first active material layer contains first active substance particles. The first active substance particles have an equivalent sphericity X₁ as represented by the following Formula (1):

$${X}_{1} = 3 / ( {S}_{1} {R}_{1} {ρ}_{1} ) , \qquad Formula ( 1 )$$

where 0.05≤X₁≤0.8, R₁ is the median radius of the first active substance particles in the unit of μm; S₁ is the specific surface area of the first active substance particles in the unit of m²/g; and ρ₁ is the true density of the first active substance particles in the unit of g/cm³.

As described herein, the median radius of the active substance particles is ½ of a quantity distribution median particle size D50 of the active substance particles. D50 refers to an average particle size (diameter) of the active substance particles in the unit of μm. The foregoing particle size D50 is a corresponding diameter when a cumulative quantity percentage of the active substance particles reaches 50%. The specific surface area S of the active substance particles may be detected by a nitrogen adsorption desorption test.

As described herein, when electrode active substance particles in an electrode plate are randomly selected to determine the particle size D50 of the electrode active substance particles, a test method includes the following steps: a) a battery that is completely discharged is disassembled to obtain the electrode plate, and then any position in a dressing area is cut through argon ions to obtain an electrode plate cross section sample; b) the foregoing electrode plate cross section sample is placed in a Scanning Electron Microscope (SEM) for observing, and a voltage and a magnification of the SEM are adjusted according to actual requirements to ensure that enough particles in the foregoing sample can be seen clearly and shot to obtain an SEM picture; c) the obtained SEM picture may be imported into gray scale debugging software (for example, Geodict) to count the particle sizes of the particles, or the particle sizes of the particles may alternatively be identified and counted by directly using artificial naked eyes; and d) 20 to 30 experiments are performed cumulatively, the quantity of the particles counted in each experiment is less than 500pcs, and the particle size D50 of the electrode active substance particles in an electrode plate is obtained after the foregoing results are counted.

The active substance particles in the active material layer of a lithium ion battery provided by the present disclosure have an equivalent sphericity as represented by a formula X₁=3/(S₁R₁ρ₁), where 0.05≤X₁≤0.8, so that the lithium ion battery provided by the present disclosure is beneficial to improving the capacity retention rate and the liquid phase diffusion impedance of the electrode based on good compacted density.

In some embodiments of the present disclosure, when the electrode plate is a positive electrode plate, 0.10≤X₁≤0.8.

In some embodiments of the present disclosure, when the electrode plate is a negative electrode plate, 0.05≤X₁≤0.8.

In some embodiments of the present disclosure, the secondary battery electrode plate further includes a second active material layer. The second active material layer is located on a surface, deviating from the surface of the current collector, of the first active material layer. The second active material layer contains second active substance particles. The second active substance particles have an equivalent sphericity X₂ as represented by the following Formula (2):

$${X}_{2} = 3 / ( {S}_{2} {R}_{2} {ρ}_{2} ) , \qquad Formula ( 2 )$$

where R₂ is the median radius of the second active substance particles in the unit of μm; S₂ is the specific surface area of the second active substance particles in the unit of m²/g; ρ₂ is the true density of the second active substance particles in the unit of g/cm³; and the sphericity X₂ of the second active substance particles is greater than the equivalent sphericity X₁ of the first active substance particles.

The secondary battery electrode plate of the present disclosure has double active material layers with different particle sphericities. The equivalent sphericity of the first active substance particles close to a nearby current collector is much smaller than the equivalent sphericity of the second active substance particles far away from the current collector. The higher the equivalent sphericity of the active material particles, the higher the isotropy degree among the particles, the smaller the total surface area of the particles under the same volume, the shorter the paths that lithium ions flow in the electrode, the lower the overall tortuosity of the electrode, and the lower the resistance to diffusion of the lithium ions. The active substance particles with high sphericity in the second active material layer are used, so that the isotropy degree of surface particles may be increased, and physical rebound and expansion during cycling of the electrode may be reduced. The equivalent sphericity of the active substance particles of the first active material layer is low, so that particle accumulation may have relatively high compaction and the energy density of the electrode may be improved. As described herein, the active substance materials with different sphericity are matched, so that diffusion paths of the lithium ions may be optimized, the tortuosity of the electrode may be effectively reduced while ensuring the compaction of the electrode, the capacity retention rate of the electrode is further improved, and the liquid phase diffusion impedance of the electrode is reduced.

In some embodiments of the present disclosure, 0.05≤X₁≤0.4, preferably, 0.1≤X₁≤0.3. Within this range, the first active material layer of the secondary battery electrode plate may be ensured to have relatively low sphericity and relatively high compacted density, so that the electrode has a higher capacity retention rate and lower liquid phase diffusion impedance, thereby further optimizing electrochemical performance of the electrode.

In some embodiments of the present disclosure, 0.2≤X₂≤0.8, preferably, 0.2≤X₂≤0.5. Within this range, the second active material layer of the secondary battery electrode plate may be ensured to have relatively low sphericity and relatively high lithium ion diffusion capacity.

In some embodiments of the present disclosure, 0.07≤X₂−X₁≤0.5, preferably, 0.1≤X₂−X₁≤0.5, preferably, 0.2≤X₂−X₁≤0.4. When a difference between the equivalent sphericity X₂ of the second active substance particles and the equivalent sphericity X₁ of the first active substance particles, the matching of the particle sphericity of the two active material layers is further optimized, and the electrochemical performance of the secondary battery electrode plate may be further improved.

In some embodiments of the present disclosure, the surface density of the first active material layer is Y₁=ε×L, and the surface density of the second active material layer is Y₂=(1−ε)×L, where L is a total surface density of the first active material layer and the second active material layer in the unit of g/m², one side of the current collector is coated with the first active material layer, or each of two sides of the current collector is coated with the first active material layer, and the surface, deviating from the current collector, of each first active material layer is coated with the second active material layer. If one side of the current collector is coated with the first active material layer, when the electrode plate is a positive electrode plate, 50≤L≤300, and when the electrode plate is a negative electrode plate, 23≤L≤138; if each of the two sides of the current collector is coated with the first active material layer, when the electrode plate is a negative electrode plate, 100≤L≤600, and when the electrode plate is a negative electrode plate, 46≤L≤276; and E is an adjustment parameter, 0.2≤ε≤0.8. It is appropriate when the thickness of the secondary battery electrode plate is within the foregoing range, the capacity retention rate of the electrode may be further improved, and the liquid phase diffusion impedance of the electrode may be reduced.

As described herein, a relationship between the surface density of the active material layers of the secondary battery electrode plate and the equivalent sphericity of the active material particles affects the electrochemical performance of the electrode. In some embodiments of the present disclosure, 0.1≤(X₂/Y₂)/(X₁/Y₁)≤6, preferably, 0.25≤(X₂/Y₂)/(X₁/Y₁)≤4.5, more preferably, 3≤(X₂/Y₂)/(X₁/Y₁)≤4.5. The higher the proportion of the surface density of the active material layer with high sphericity, the lower the overall tortuosity of the electrode, meanwhile, the lower the compaction capacity of the electrode, and the lower the liquid phase diffusion impedance of the electrode. The lower the proportion of the surface density of the active material layer with high sphericity, the higher the tortuosity of the electrode, the higher the compaction capacity, and the higher the liquid phase diffusion impedance of the electrode. When a relationship between parameters of the secondary battery electrode plate is within the foregoing range, consideration may be given to both the liquid phase diffusion and energy density of the secondary battery electrode plate, so that the energy density and the liquid phase diffusion impedance of the electrode may be maintained within an appropriate range.

In some embodiments of the present disclosure, when the electrode plate is a positive electrode plate, R₁ and R₂ of the first active substance particles are respectively and independently any values ranging from 0.05 to 5.0, and S₁ and S₂ are respectively and independently any values ranging from 0.5 to 20. When the electrode plate is a negative electrode plate, R₁ and R₂ of the first active substance particles are respectively and independently any values ranging from 1 to 20, and S₁ and S₂ are respectively and independently any values ranging from 0.5 to 5. ρ₁ and ρ₂ are respectively the true density of the first active substance particles and the second active substance particles, for example, the true density of lithium cobalt oxide is 5.1 g/cm³; the true density of a ternary material is 4.8 g/cm³; the true density of lithium manganate is 4.2 g/cm³; the true density of lithium iron phosphate is 3.6 g/cm³; and the true density of graphite is 2.26 g/cm³.

In some embodiments of the present disclosure, when the electrode plate is a positive electrode plate, the total surface density of the first active material layer and the second active material layer is 50 to 300 g/m² and the compacted density is 2.0 to 2.7 g/m3. When the electrode plate is a negative electrode plate, the total surface density of the first active material layer and the second active material layer is 23 to 138 g/m² and the compacted density is 1.0 to 2.0 g/m3. The total surface density refers to the total density of the first active material layer and the second active material layer on a single side of the current collector, and is obtained by cutting an electrode plate with a specific surface density and weighing. As described herein, the total surface density is measured by a method for weighing the weight of a certain area of electrode plate except for the current collector, the compacted density is obtained by measuring the thickness of the electrode plate after rolling and the surface density of the electrode plate, compacted density=surface density/(thickness of electrode plate after rolling minus thickness of current collector).

In some embodiments of the present disclosure, based on the total weight of the first active material layer, the content of the first active substance particles is 90% to 99% by weight, preferably, 94% to 97% by weight. Based on the total weight of the second active material layer, the content of the second active substance particles is 90% to 99% by weight, preferably, 94% to 97% by weight.

In some embodiments of the present disclosure, the secondary battery electrode plate is a positive electrode, the first active substance particles and the second active substance particles may use various active materials for positive electrodes known to those skilled in the art, for example, the first active substance particles and the second active substance particles may be respectively and independently selected from one or more of LiFePO₄, Li₃V₂(PO₄)₃, LiMn₂O₄, LiMnO₂, LiNiO₂, LiCoO₂, LiVPO₄F, and LiFeO₂. The first active material layer and the second active material layer further respectively and independently contain a conductive agent and a bonding agent. The conductive agent and the bonding agent may alternatively be known to those skilled in the art, preferably, the conductive agent may be selected from one or more of carbon nanotubes, carbon black, graphite, graphene, and carbon nanofibers; and the bonding agent may be selected from one or more of polyvinylidene fluoride, polytetrafluoroethylene, butadiene styrene rubber, and polyacrylate.

In some embodiments of the present disclosure, the secondary battery electrode plate is a negative electrode, the first active substance particles and the second active substance particles may use various active materials for positive electrodes known to those skilled in the art, for example, the first active substance particles and the second active substance particles may be respectively independently selected from one or more of graphite, petroleum coke, organic cracked carbon, intermediate phase carbon microspheres, carbon fibers, tin alloys, and silicon alloys.

A second aspect of the present disclosure provides a method for preparing a secondary battery electrode plate. The method includes the following steps. In step S1, a current collector is coated with first slurry to obtain an electrode plate with the current collector coated with a first slurry layer; and in step S2, the electrode plate is rolled.

The first slurry contains first active substance particles. The first active substance particles have an equivalent sphericity X₁ as represented by the following Formula (1), X₁=3/(S₁R₁ρ₁) Formula (1), where 0.05≤X₁≤0.8, R₁ is the median radius of the first active substance particles in the unit of μm; S₁ is the specific surface area of the first active substance particles in the unit of m²/g; and ρ₁ is the true density of the first active substance particles in the unit of g/cm³. The method provided by the present disclosure may prepare the secondary battery electrode plate with a high capacity retention rate of the electrode and low liquid phase diffusion impedance of the electrode.

In some embodiments of the present disclosure, when the electrode plate is a positive electrode plate, 0.10≤X₁≤0.8.

In some embodiments of the present disclosure, when the electrode plate is a negative electrode plate, 0.05≤X₁≤0.8.

In some embodiments of the present disclosure, step S1 includes the following steps. The current collector is coated with the first slurry and second slurry to obtain an electrode plate sequentially coated with the first slurry layer and the second slurry layer in a direction far away from the current collector. The second slurry contains second active substance particles, and the second active substance particles have an equivalent sphericity X₂ as represented by the following Formula (2): X₂=3/(S₂R₂ρ₂) Formula (2), where R₂ is the median radius of the second active substance particles in the unit of μm; S₂ is the specific surface area of the second active substance particles in the unit of m²/g; ρ₂ is the true density of the second active substance particles in the unit of g/cm³; and the sphericity X₂ of the second active substance particles is greater than the equivalent sphericity X₁ of the first active substance particles.

A method for coating the current collector with the first slurry and the second slurry is not specifically limited in the present disclosure. In some embodiments of the present disclosure, in step S1, the current collector may be coated with the first slurry and the second slurry through a double-layer coating die head. In some embodiments of the present disclosure, in step S1, the current collector is coated with the first slurry to obtain an electrode plate coated with a first slurry layer, and then the coating the first slurry layer with the second slurry.

In some embodiments of the present disclosure, in step S1, the viscosity of the first slurry at 20° C. and 50s⁻¹ is 2000 to 3000 mPa·s, and the viscosity of the second slurry at 20° C. and 50s⁻¹ is 2000 to 3000 mPa·s. The surface density of the first slurry layer is 50 to 150 g/m², and the surface density of the second slurry layer is 50 to 150 g/m².

As described herein, rolling is a conventional method for preparing an electrode by those skilled in the art. Rolling is performed according to a target compacted density of the electrode, for example, may be one-time rolling, multiple rolling, cold rolling, and hot rolling.

As described herein, the first slurry and the second slurry further contain a solvent. The solvent contained in the first slurry and the second slurry described herein is not specifically limited in the present disclosure, for example, may be, but is not limited to, water, N-methylpyrrolidone (NMP), and ethyl alcohol.

In some embodiments of the present disclosure, the content of the first active substance particles in the first slurry is 40% to 70% by weight, preferably, 50% to 70% by weight. The content of the second active substance particles in the second slurry is 30% to 70% by weight, preferably, 50% to 70% by weight.

In some embodiments of the present disclosure, a positive electrode is prepared by the method in the present disclosure. In step S1, the first active substance particles and the second active substance particles may use various active materials for positive electrodes known to those skilled in the art, for example, the first active substance particles and the second active substance particles may be respectively and independently selected from one or more of LiFePO₄, Li₃V₂(PO₄)₃, LiMn₂O₄, LiMnO₂, LiNiO₂, LiCoO₂, LiVPO₄F, and LiFeO₂. The first active material layer and the second active material layer further respectively and independently contain a conductive agent and a bonding agent. The conductive agent and the bonding agent may alternatively be known to those skilled in the art, preferably, the conductive agent may be selected from one or more of carbon nanotubes, carbon black, graphite, graphene, and carbon nanofibers; and the bonding agent may be selected from one or more of polyvinylidene fluoride, polytetrafluoroethylene, butadiene styrene rubber, and polyacrylate. In some embodiments of the present disclosure, the first slurry and the second slurry further respectively and independently contain a conductive agent and a bonding agent, preferably, the conductive agent may be known to those skilled in the art, for example, the conductive agent may be selected from one or more of carbon nanotubes, carbon black, graphite, graphene, and carbon nanofibers; and the bonding agent may be selected from one or more of polyvinylidene fluoride, polytetrafluoroethylene, butadiene styrene rubber, and polyacrylate.

In some embodiments of the present disclosure, a negative electrode is prepared by the present disclosure. In step S1, the first active substance particles and the second active substance particles may use various active materials for negative electrodes known to those skilled in the art, for example, the first active substance particles and the second active substance particles may be respectively independently selected from one or more of graphite, petroleum coke, organic cracked carbon, intermediate phase carbon microspheres, carbon fibers, tin alloys, and silicon alloys.

In some embodiments of the present disclosure, 0.05≤X₁≤0.4, more preferably, 0.1≤X₁≤0.3.

In some embodiments of the present disclosure, 0.2≤X₂≤0.8, more preferably, 0.2≤X₂≤0.5.

In some embodiments of the present disclosure, 0.07≤X₂−X₁≤0.5, more preferably, 0.2≤X₂−X₁≤0.4.

In some embodiments of the present disclosure, when the electrode plate is a positive electrode plate, R₁ and R₂ of the first active substance particles are respectively and independently any values ranging from 0.05 to 5, and S₁ and S₂ are respectively and independently any values ranging from 0.5 to 20; when the electrode plate is a negative electrode plate, R₁ and R₂ of the first active substance particles are respectively and independently any values ranging from 1 to 20, and S₁ and S₂ are respectively and independently any values ranging from 0.5 to 5; ρ₁ and ρ₂ are respectively the true density of the first active substance particles and the second active substance particles, for example, the true density of lithium cobalt oxide is 5.1 g/cm³; the true density of a ternary material is 4.8 g/cm³; the true density of lithium manganate is 4.2 g/cm³; the true density of lithium iron phosphate is 3.6 g/cm³; and the true density of graphite is 2.26 g/cm³.

A third aspect of the present disclosure provides a secondary battery. The secondary battery includes the secondary battery electrode plate according to the first aspect of the present disclosure. The secondary battery of the present disclosure has a relatively high capacity retention rate and relatively low liquid phase diffusion impedance of the electrode.

The present disclosure is further described below through embodiments, but the present disclosure is not limited in any way accordingly.

### Embodiment 1

Step S1, one side of a positive current collector was coated with first slurry and second slurry through a double-layer coating die head to obtain an electrode plate coated with a first slurry layer and a second slurry layer. The positive current collector was coated with the first slurry layer, and the first slurry layer was coated with the second slurry layer. Both the first slurry and the second slurry contained lithium iron phosphate, Polyvinylidene Fluoride (PVDF), carbon tubes, carbon black, and NMP. The content of the lithium iron phosphate in the first slurry layer was 60.1% by weight, the viscosity of the first slurry at 20° C. and 50s′ was 2560 mPa·s, and the surface density of the first slurry layer was 125 g/m². The content of the lithium iron phosphate in the second slurry layer was 60.3% by weight, the viscosity of the second slurry at 20° C. and 50s⁻¹ was 2600 mPa·s, and the surface density of the second slurry layer was 125 g/m²; and the total surface density of the first slurry layer and the second slurry layer was 250 g/m².

Step S2, the electrode plate was dried and rolled, and the first slurry layer formed the first active material layer, and the second slurry layer formed the second active material layer to obtain a positive electrode of a lithium ion battery. The compacted density of the positive electrode of the lithium ion battery was 2.50 g/cm³.

The median radius R₁ of the lithium iron phosphate in the first active material layer was 0.34 μm, the specific surface area S₁ was 15 m²/g, the true density ρ₁ was 3.6 g/cm³, and the equivalent sphericity X₁ was 0.163. The median radius R₂ of the lithium iron phosphate in the second active material layer was 0.34 μm, the specific surface area S₂ was 10 m²/g, the true density ρ₂ was 3.6 g/cm³, and the equivalent sphericity X₂ was 0.245. Summary of various parameters of the positive electrode of the lithium ion battery is shown in Table 1.

### Embodiment 2

A positive electrode was prepared by a method that was the same as that in Embodiment 1. The only difference was that, in step S1, the median radius R₂ of the lithium iron phosphate in the second active material layer was 0.34 μm, the specific surface area S₂ was 7.2 m²/g, the true density ρ₂ was 3.6 g/cm³, and the equivalent sphericity X₂ was 0.34.

### Embodiment 3

A positive electrode was prepared by a method that was the same as that in Embodiment 1. The only difference was that, in step S1, the median radius R₂ of the lithium iron phosphate in the second active material layer was 0.25 μm, the specific surface area S₂ was 6.6 m²/g, the true density ρ₂ was 3.6 g/cm³, and the equivalent sphericity X₂ was 0.505.

### Embodiment 4

A positive electrode was prepared by a method that was the same as that in Embodiment 2. The only difference was that, in step S1, the median radius R₁ of the lithium iron phosphate in the first active material layer was 0.38 μm, the specific surface area S₁ was 25 m²/g, the true density ρ₁ was 3.6 g/cm³, and the equivalent sphericity X₁ was 0.088.

### Embodiment 5

A positive electrode was prepared by a method that was the same as that in Embodiment 2. The only difference was that, in step S1, the median radius R₁ of the lithium iron phosphate in the first active material layer was 0.34 μm, the specific surface area S₁ was 12 m²/g, the true density ρ₁ was 3.6 g/cm³, and the equivalent sphericity X₁ was 0.204.

### Embodiment 6

A positive electrode was prepared by a method that was the same as that in Embodiment 2. The only difference was that, in step S1, the surface density of the first active material layer was 145 g/m², and the surface density of the second active material layer was 105 g/m².

### Embodiment 7

A positive electrode was prepared by a method that was the same as that in Embodiment 2. The only difference was that, in step S1, the surface density of the first active material layer was 165 g/m², and the surface density of the second active material layer was 85 g/m².

### Embodiment 8

A positive electrode was prepared by a method that was the same as that in Embodiment 3. The only difference was that, in step S1, the surface density of the first active material layer was 100 g/m², and the surface density of the second active material layer was 150 g/m².

### Embodiment 9

A positive electrode was prepared by a method that was the same as that in Embodiment 3. The only difference was that, in step S1, the surface density of the first active material layer was 70 g/m², and the surface density of the second active material layer was 180 g/m².

### Embodiment 10

A positive electrode was prepared by a method that was the same as that in Embodiment 3. The difference was that, in step S1, the specific surface area S₁ of the lithium iron phosphate in the first active material layer was 9.5 m²/g, the median radius R₁ was 0.22 μm, the true density was 3.6 g/cm³, and the surface density of the first active material layer was 70 g/m². The specific surface area S₂ of the lithium iron phosphate in the second active material layer was 5.2 m²/g, the median radius R₂ was 0.22 μm, the true density was 3.6 g/cm³, and the surface density of the second active material layer was 180 g/m².

### Embodiment 11

A positive electrode was prepared by a method that was the same as that in Embodiment 3. The difference was that, in step S1, the specific surface area S₁ of the lithium iron phosphate in the first active material layer was 12 m²/g, the median radius R₁ was 0.34 μm, the true density was 3.6 g/cm³, and the surface density of the first active material layer was 70 g/m². The specific surface area S₂ of the lithium iron phosphate in the second active material layer was 6.6 m²/g, the median radius R₂ was 0.25 μm, the true density was 3.6 g/cm³, and the surface density of the second active material layer was 180 g/m².

### Embodiment 12

Step S1, one side of a negative current collector was coated with first slurry and second slurry through a double-layer coating die head to obtain an electrode plate coated with a first slurry layer and a second slurry layer. The negative current collector was coated with the first slurry layer, and the first slurry layer was coated with the second slurry layer. The surface density of the first slurry layer was 58 g/m², the surface density of the second slurry layer was 58 g/m², and the total surface density was 116 g/m².

Step S2, the electrode plate was dried and rolled to obtain a negative electrode of a lithium ion battery. The compacted density of the negative electrode of the lithium ion battery was 1.50 g/cm³.

Both the first slurry and the second slurry contained graphite, SBR, CMC, carbon black, and water. The median radius R₁ of the graphite in the first active material layer was 3 μm, the specific surface area S₁ was 3 m²/g, the true density ρ₁ was 2.1 g/cm³, and the equivalent sphericity X₁ was 0.16. The viscosity of the first slurry at 20° C. and 50s⁻¹ was 2560 mPa·s, and the content of the graphite in the first slurry was 45% by weight. The median radius R₂ of the graphite in the second active material layer was 3 μm, the specific surface area S₂ was 1.4 m²/g, the true density ρ₂ was 2.1 g/cm³, and the equivalent sphericity X₂ was 0.340. The viscosity of the second slurry at 20° C. and 50s⁻¹ was 2660 mPa·s, and the content of the graphite in the second slurry was 45% by weight. Summary of various parameters of the negative electrode of the lithium ion battery is shown in Table 1.

### Embodiment 13

Step S1, one side of a positive current collector was coated with first slurry and second slurry through a coating die head to obtain an electrode plate coated with a first slurry layer. The first slurry contained lithium iron phosphate, Polyvinylidene Fluoride (PVDF), carbon tubes, carbon black, and NMP. The content of the lithium iron phosphate in the first slurry layer was 60.1% by weight, the viscosity of the first slurry at 20° C. and 50s⁻¹ was 2450 mPa·s, and the surface density of the first slurry layer was 250 g/m².

Step S2, the electrode plate was dried and rolled, and the first slurry layer formed the first active material layer to obtain a positive electrode of a lithium ion battery. The compacted density of the positive electrode of the lithium ion battery was 2.50 g/cm³.

The median radius R₁ of the lithium iron phosphate in the first active material layer was 0.30 μm, the specific surface area S₁ was 8 m²/g, the true density ρ₁ was 3.6 g/cm³, and the equivalent sphericity X₁ was 0.347. Summary of various parameters of the positive electrode of the lithium ion battery is shown in Table 1.

### Embodiment 14

Step S1, one side of a positive current collector was coated with first slurry through a coating die head to obtain an electrode plate coated with a first slurry layer. The first slurry contained lithium iron phosphate, Polyvinylidene Fluoride (PVDF), carbon tubes, carbon black, and NMP. The content of the lithium iron phosphate in the first slurry layer was 59.3% by weight, and the viscosity of the first slurry at 20° C. and 50s⁻¹ was 2570 mPa·s. The surface density of the first slurry layer was 250 g/m².

Step S2, the electrode plate was dried and rolled, and the first slurry layer formed the first active material layer to obtain a positive electrode of a lithium ion battery. The compacted density of the positive electrode of the lithium ion battery was 2.50 g/cm³.

The median radius R₁ of the lithium iron phosphate in the first active material layer was 0.2 μm, the specific surface area S₁ was 8 m²/g, the true density ρ₁ was 3.6 g/cm³, and the equivalent sphericity X₁ was 0.520. Summary of various parameters of the positive electrode of the lithium ion battery is shown in Table 1.

### Embodiment 15

Step S1, one side of a positive current collector was coated with first slurry through a coating die head to obtain an electrode plate coated with a first slurry layer. The first slurry contained lithium iron phosphate, Polyvinylidene Fluoride (PVDF), carbon tubes, carbon black, and NMP. The content of the lithium iron phosphate in the first slurry layer was 58.9% by weight, and the viscosity of the first slurry at 20° C. and 50s⁻¹ was 2670 mPa·s. The surface density of the first slurry layer was 250 g/m².

Step S2, the electrode plate was dried and rolled, and the first slurry layer formed the first active material layer to obtain a positive electrode of a lithium ion battery. The compacted density of the positive electrode of the lithium ion battery was 2.50 g/cm³.

The median radius R₁ of the lithium iron phosphate in the first active material layer was 0.30 μm, the specific surface area S₁ was 18 m²/g, the true density ρ₁ was 3.6 g/cm³, and the equivalent sphericity X₁ was 0.154. Summary of various parameters of the positive electrode of the lithium ion battery is shown in Table 1.

### Embodiment 16

Step S1, one side of a negative current collector was coated with first slurry through a coating die head to obtain an electrode plate coated with a first slurry layer. The first slurry contained graphite, SBR, CMC, carbon black, and water. The content of the graphite on the first slurry layer was 46.3% by weight, the surface density was 116 g/m², and compacted density was 1.60 g/cm³.

Step S2, the electrode plate was dried and rolled to obtain a negative electrode of a lithium ion battery. The compacted density of the negative electrode of the lithium ion battery was 1.60 g/cm³.

The median radius R₁ of the graphite in the first active material layer was 4.0 μm, the specific surface area S₁ was 1.0 m²/g, the true density ρ₁ was 2.1 g/cm³, and the equivalent sphericity X₁ was 0.357. The viscosity of the first slurry at 20° C. and 50s⁻¹ was 2750 mPa·s. Summary of various parameters of the negative electrode of the lithium ion battery is shown in Table 1.

### Embodiment 17

One side of a positive current collector was coated with first slurry in Embodiment 1, and an obtained electrode plate coated with a first slurry layer was rolled under a condition of the compacted density of 2.50 g/cm³ to obtain a positive electrode of a lithium ion battery.

The first slurry contained lithium iron phosphate, Polyvinylidene Fluoride (PVDF), carbon tubes, carbon black, and NMP. The median radius R of the lithium iron phosphate was 0.34 μm, the specific surface area S was 15 m²/g, the true density p was 3.6 g/cm³, and the equivalent sphericity X₁ was 0.163. The viscosity of the first slurry at 20° C. and 50s⁻¹ was 2560 mPa·s, and the content of the lithium iron phosphate in the first slurry was 60.1% by weight. The total surface density of the positive electrode of the lithium ion battery was 250 g/m².

### Embodiment 18

One side of a positive current collector was coated with second slurry in Embodiment 1, and an obtained electrode plate coated with a second slurry layer was rolled under a condition of the compacted density of 2.50 g/cm³ to obtain a positive electrode of a lithium ion battery.

The second slurry contained lithium iron phosphate, Polyvinylidene Fluoride (PVDF), carbon tubes, carbon black, and NMP. The median radius R of the lithium iron phosphate was 0.34 μm, the specific surface area S was 10 m²/g, the true density ρ was 3.6 g/cm³, and the equivalent sphericity X₂ was 0.245. The viscosity of the second slurry at 20° C. and 50s⁻¹ was 2600 mPa·s, and the content of the lithium iron phosphate in the second slurry was 60.3% by weight. The total surface density of the positive electrode of the lithium ion battery was 250 g/m².

### Embodiment 19

One side of a positive current collector was coated with third slurry, and an obtained electrode plate coated with third slurry layer was dried and rolled to obtain a positive electrode of a lithium ion battery. The compacted density of the positive electrode of the lithium ion battery was 2.50 g/cm³.

The surface density of the third slurry layer was 250 g/m², and the viscosity of the third slurry at 20° C. and 50s⁻¹ was 2700 mPa·s. The third slurry contained two types of lithium iron phosphate, Polyvinylidene Fluoride (PVDF), carbon tubes, carbon black, and NMP. The first type of lithium iron phosphate was the same as the lithium iron phosphate in the first slurry in Embodiment 1. The second type of lithium iron phosphate was the same as the lithium iron phosphate in the second slurry in Embodiment 1. The content of the lithium iron phosphate in the third slurry was 60.2%.

### Embodiment 20

A positive electrode was prepared by a method that was the same as that in Embodiment 1. The only difference was that, in step S1, one side of a positive current collector was coated with a second slurry layer, and the second slurry layer was coated with a first slurry layer.

### Embodiment 21

A positive electrode was prepared by a method that was the same as that in Embodiment 13. The difference was that, in step S1, the median radius R₁ of the lithium iron phosphate in the first active material layer was 0.2 μm, the specific surface area S₁ was 5.3 m²/g, the true density ρ₁ was 3.6 g/cm³, and the equivalent sphericity X₁ was 0.786.

### Comparative Example 1

A positive electrode was prepared by a method that was the same as that in Embodiment 14. The difference was that, the median radius R₁ of the lithium iron phosphate in the first active material layer was 0.16 μm, the specific surface area S₁ was 6.1 m²/g, the true density ρ₁ was 3.6 g/cm³, and the equivalent sphericity X₁ was 0.853.

### Comparative Example 2

A positive electrode was prepared by a method that was the same as that in Embodiment 14. The difference was that, the median radius R₁ of the lithium iron phosphate in the first active material layer was 0.8 μm, the specific surface area S₁ was 22 m²/g, the true density ρ₁ was 3.6 g/cm³, and the equivalent sphericity X₁ was 0.047.

### Comparative Example 3

A negative electrode was prepared by a method that was the same as that in Embodiment 16. The difference was that, the median radius R₁ of the lithium iron phosphate in the first active material layer was 3.5 μm, the specific surface area S₁ was 0.5 m²/g, the true density ρ₁ was 2.1 g/cm³, and the equivalent sphericity X₁ was 0.816.

### Comparative Example 4

A negative electrode was prepared by a method that was the same as that in Embodiment 16. The difference was that, the median radius R₁ of the lithium iron phosphate in the first active material layer was 7 μm, the specific surface area S₁ was 4.2 m²/g, the true density ρ₁ was 2.1 g/cm³, and the equivalent sphericity X₁ was 0.0485.

TABLE 1

| | X₁ | X₂ | Y₁, g/m² | Y₂, g/m² | L, g/m² | (X₂/Y₂)/(X₁/Y₁) | X₂ − X₁ |
|---|---|---|---|---|---|---|---|
| Embodiment 1 | 0.163 | 0.245 | 125 | 125 | 250 | 1.50 | 0.082 |
| Embodiment 2 | 0.163 | 0.340 | 125 | 125 | 250 | 2.08 | 0.177 |
| Embodiment 3 | 0.163 | 0.505 | 125 | 125 | 250 | 3.09 | 0.342 |
| Embodiment 4 | 0.088 | 0.340 | 125 | 125 | 250 | 3.86 | 0.252 |
| Embodiment 5 | 0.204 | 0.340 | 125 | 125 | 250 | 1.67 | 0.136 |
| Embodiment 6 | 0.163 | 0.340 | 145 | 105 | 250 | 2.88 | 0.177 |
| Embodiment 7 | 0.163 | 0.340 | 165 | 85 | 250 | 4.04 | 0.177 |
| Embodiment 8 | 0.163 | 0.505 | 100 | 150 | 250 | 2.07 | 0.342 |
| Embodiment 9 | 0.163 | 0.505 | 70 | 180 | 250 | 1.20 | 0.342 |
| Embodiment 10 | 0.399 | 0.728 | 125 | 125 | 250 | 2.01 | 0.402 |
| Embodiment 11 | 0.204 | 0.505 | 180 | 70 | 250 | 6.37 | 0.301 |
| Embodiment 12 | 0.158 | 0.340 | 58 | 58 | 116 | 2.15 | 0.182 |
| Embodiment 13 | 0.347 | / | 250 | / | 250 | / | / |
| (Single layer) | | | | | | | |
| Embodiment 14 | 0.520 | / | 250 | / | 250 | / | / |
| (Single layer) | | | | | | | |
| Embodiment 15 | 0.154 | / | 250 | | 250 | / | / |
| (Single layer) | | | | | | | |
| Embodiment 16 | 0.357 | / | 116 | / | 116 | / | / |
| (Single layer) | | | | | | | |
| Embodiment 17 | 0.163 | / | 250 | / | 250 | / | / |
| (Single layer) | | | | | | | |
| Embodiment 18 | 0.245 | / | 250 | / | 250 | / | / |
| (Single layer) | | | | | | | |
| Embodiment 19 | 0.163 + 0.245 | | 250 | / | 250 | / | / |
| (Single layer) | | | | | | | |
| Embodiment 20 | 0.245 | 0.163 | 125 | 125 | 250 | 0.68 | −0.09 |
| Embodiment 21 | 0.786 | / | 250 | / | 250 | / | / |
| (Single layer) | | | | | | | |
| Comparative | 0.853 | / | 250 | / | 250 | / | / |
| example 1 | | | | | | | |
| (Single layer) | | | | | | | |
| Comparative | 0.047 | / | 250 | / | 250 | / | / |
| example 2 | | | | | | | |
| (Single layer) | | | | | | | |
| Comparative | 0.816 | / | 116 | / | 116 | / | / |
| example 3 | | | | | | | |

### Test Examples

(1) The electrode plates prepared in the embodiments and the comparative examples were assembled into symmetrical batteries. For example, when the liquid phase impedance of the positive electrode plate prepared in Embodiment 1 was tested, the two positive electrode plates prepared in Embodiment 1 were assembled into symmetrical batteries to test the liquid phase impedance. When the liquid phase impedance of the negative electrode plate prepared in Embodiment 12 was tested, the two negative electrode plates prepared in Embodiment 12 were assembled into symmetrical batteries to test the liquid phase impedance. When the liquid phase impedance of the positive electrode plate prepared in Embodiment 1 was tested, the two positive electrode plates prepared in Embodiment 1 were assembled into symmetrical batteries to test the liquid phase impedance. A dimension of the electrode plate was 62 cm×72 cm, and was tested through electrochemical impedance spectroscopy. A test was performed within a frequency range of 100 kHz to 0.01 Hz, and test results were fitted and calculated to obtain the liquid phase diffusion impedance of the electrode.

(2) The positive electrode plates prepared in embodiments 1 to 11, 13 to 15, and 17 to 21, the negative electrode plate prepared in Embodiment 12, and electrolyte were combined to sequentially obtain batteries A1 to A11, A13 to A15, and A17 to A21. The positive electrode plates prepared in Embodiments 1 and 2, the negative electrode plate prepared in Embodiment 12, and electrolyte were combined to obtain batteries A22 and A23. The negative electrode plates prepared in Embodiment 12 and Embodiment 16, the positive electrode plate prepared in Embodiment 1, and electrolyte were combined to obtain batteries A1 and A16. The negative electrode plate prepared in Comparative examples 3 and 4, the positive electrode plate prepared in Embodiment 1, and electrolyte were combined to obtain batteries A24 and A25. The positive electrode plate prepared in Embodiment 1, the negative electrode plate prepared in Comparative example 3, and electrolyte were combined to obtain a battery A26. The capacity retention rates of 2C discharge relative to the 0.2C discharge of the foregoing prepared batteries were tested.

(3) Unrolled electrode plates with the width of 5 cm in the embodiments and the comparative examples passed through a roller. The roller applied a given pressure of 5 t to measure the compacted density after the electrode plates are rolled.

The foregoing test results are as shown in Table 2.

TABLE 2

| | | Compacted density | Lithium ion | 2 C/ |
|---|---|---|---|---|
| | | of corresponding | liquid phase | 0.2 C |
| | | electrode plate | diffusion | dis- |
| | Battery | under pressure of | impedance, | charge |
| | number | 5 t (g/cm³) | Ω | rate |
| Test example 1 | A1 | 2.65 | 0.65 | 0.920 |
| Test example 2 | A2 | 2.62 | 0.60 | 0.925 |
| Test example 3 | A3 | 2.58 | 0.54 | 0.930 |
| Test example 4 | A4 | 2.65 | 0.71 | 0.90 |
| Test example 5 | A5 | 2.62 | 0.55 | 0.931 |
| Test example 6 | A6 | 2.65 | 0.65 | 0.918 |
| Test example 7 | A7 | 2.67 | 0.71 | 0.905 |
| Test example 8 | A8 | 2.57 | 0.49 | 0.951 |
| Test example 9 | A9 | 2.55 | 0.43 | 0.955 |
| Test example 10 | A10 | 2.50 | 0.75 | 0.881 |
| Test example 11 | A11 | 2.52 | 0.72 | 0.893 |
| Test example12 | A1 | 2.65 | 0.65 | 0.920 |
| Test example13 | A13 | 2.52 | 0.71 | 0.910 |
| Test example 14 | A14 | 2.48 | 0.55 | 0.925 |
| Test example 15 | A15 | 2.70 | 0.9 | 0.850 |
| Test example 16 | A16 | 1.58 | 0.35 | 0.935 |
| Test example 17 | A17 | 2.68 | 0.80 | 0.891 |
| Test example 18 | A18 | 2.58 | 0.70 | 0.911 |
| Test example 19 | A19 | 2.58 | 0.82 | 0.890 |
| Test example 20 | A20 | 2.63 | 0.92 | 0.872 |
| Test example 21 | A21 | 2.40 | 0.50 | 0.928 |
| Test example 22 | A22 | 2.10 | 0.52 | 0.880 |
| Test example 23 | A23 | 2.75 | 1.20 | 0.785 |
| Test example 24 | A24 | 1.32 | 0.58 | 0.863 |
| Test example 25 | A25 | 1.75 | 0.69 | 0.802 |
| Test example 26 | A26 | / | / | 0.652 |

Analyzing data in Table 2 and comparing test examples 13 to 15, it can be learned that, in a case of single-layer coating, the material with high sphericity has weak compaction capacity. However, under the same electrode plate compaction, the liquid phase diffusion impedance of the electrode plate is lower, and the kinetic performance is better. The electrode manufactured by a material within a sphericity range defined by the present disclosure may give consideration to both energy density (compacted density) and kinetic performance (low tortuosity and liquid phase diffusion impedance).

Test examples 1 to 11 show results of designs with an upper layer and a lower layer with different sphericity and different surface density in a case of double-layer coating. Comparing test example 1 and text example 17 (an electrode made by an upper-layer material in text example 1), text example 18 (an electrode made by a lower-layer material in text example 1), text example 19 (mixing two types of materials in text example 1), and text example 20 (exchanging the upper-layer material and the lower-layer material in text example 1), it can be learned that, through a double-layer coating design, an upper layer uses a material with high sphericity, and a lower layer uses a material with low sphericity, so that consideration may be given to both the compaction performance and the kinetic performance of the electrode.

It may further be learned from Table 2 that the compacted density of the secondary battery electrode plate prepared by the method according to the present disclosure may reach a level similar to that of a battery electrode with a single-layer low-sphericity active material layer.

Embodiments of the present disclosure are described in detail herein. However, the present disclosure is not limited to the specific details in the foregoing embodiments. Multiple simple deformations may be made to the solutions of the present disclosure within a scope of the concept of the present disclosure, and these simple deformations fall within the scope of protection of the present disclosure.

Additionally, it is to be noted that, various features described in the foregoing embodiments may be combined in any proper manner without conflict. To avoid unnecessary repetition, various possible combination manners are not separately described in the present disclosure.

In addition, various different embodiments of the present disclosure may alternatively be arbitrarily combined, and these combinations are still to be regarded as content disclosed in the present disclosure as long as not departing from the idea of the present disclosure.

1. A secondary battery electrode plate, comprising:
a current collector; and
a first active material layer, located on a surface of the current collector, wherein the first active material layer comprises first active substance particles, and wherein the first active substance particles comprise an equivalent sphericity X₁ as represented by the following Formula (1):
$${X}_{1} = 3 / ( {S}_{1} {R}_{1} {ρ}_{1} ) , \qquad Formula ( 1 )$$
wherein 0.05≤X₁≤0.8, R₁ is a median radius of the first active substance particles in a unit of μm; S₁ is a surface area of the first active substance particles in a unit of m²/g; and ρ₁ is true density of the first active substance particles in a unit of g/cm³.

2. The secondary battery electrode plate according to claim 1, wherein, based on the secondary battery electrode plate being a positive secondary battery electrode plate, 0.10≤X₁≤0.8; or based on the secondary battery electrode plate being a negative secondary battery electrode plate, 0.05≤X₁≤0.8.

3. The secondary battery electrode plate according to claim 1, further comprising a second active material layer, wherein the second active material layer is located on a surface, deviating from the surface of the current collector, of the first active material layer, the second active material layer comprises second active substance particles, and wherein the second active substance particles comprise an equivalent sphericity X₂ as represented by the following Formula (2):
$${X}_{2} = 3 / ( {S}_{2} {R}_{2} {ρ}_{2} ) , \qquad Formula ( 2 )$$
wherein R₂ is a median radius of the second active substance particles in the unit of μm; S₂ is a surface area of the second active substance particles in the unit of m²/g; ρ₂ is true density of the second active substance particles in the unit of g/cm³; and the equivalent sphericity X₂ of the second active substance particles is greater than the equivalent sphericity X₁ of the first active substance particles.

4. The secondary battery electrode plate according to claim 3, wherein 0.05≤X₁≤0.4; and 0.2≤X₂≤0.8.

5. The secondary battery electrode plate according to claim 3, wherein 0.1≤X₁≤0.3; and 0.2≤X₂≤0.5.

6. The secondary battery electrode plate according to claim 3, wherein 0.07≤X₂−X₁≤0.5.

7. The secondary battery electrode plate according to claim 3, wherein 0.2≤X₂−X₁≤0.4.

8. The secondary battery electrode plate according to claim 3, wherein, based on the secondary battery electrode plate being a positive secondary battery electrode plate, R₁ and R₂ of the first active substance particles and the second active substance particles are respectively and independently values ranging from 0.05 to 5, and S₁ and S₂ are respectively and independently values ranging from 0.5 to 20; and
based on the secondary battery electrode plate being a negative secondary battery electrode plate, R₁ and R₂ of the first active substance particles and the second active substance particles are respectively and independently values ranging from 1 to 20, and S₁ and S₂ are respectively and independently values ranging from 0.5 to 5.

9. The secondary battery electrode plate according to claim 3, wherein surface density of the first active material layer is Y₁=ε×L, and surface density of the second active material layer is Y₂=(1−ε)×L,
wherein L is total surface density of the first active material layer and the second active material layer in the unit of g/m², one side of the current collector is coated with the first active material layer, or each of two sides of the current collector is coated with the first active material layer, and the surface, deviating from the surface of the current collector, of the first active material layer is coated with the second active material layer;
based on one side of the current collector being coated with the first active material layer, and based on the secondary battery electrode plate being the positive secondary battery electrode plate, 50≤L≤300, or based on the secondary battery electrode plate being the negative secondary battery electrode plate, 23≤L≤138; or
based on each of the two sides of the current collector being coated with the first active material layer, and based on the secondary battery electrode plate being the positive secondary battery electrode plate, 100≤L≤600, or based on the secondary battery electrode plate being the negative secondary battery electrode plate, 46≤L≤276; and ε is an adjustment parameter, and 0.2≤ε≤0.8.

10. The secondary battery electrode plate according to claim 9, wherein 0.1≤(X₂/Y₂)/(X₁/Y₁)≤6.

11. The secondary battery electrode plate according to claim 9, wherein 0.25≤(X₂/Y₂)/(X₁/Y₁)≤4.5.

12. The secondary battery electrode plate according to claim 3, wherein, based on the secondary battery electrode plate being the positive secondary battery electrode plate, compacted density is 2.0 to 2.7 g/cm³; or based on the secondary battery electrode plate being the negative secondary battery electrode plate, compacted density is 1.0 to 2.0 g/cm³.

13. A method for preparing a secondary battery electrode plate, comprising:
coating a current collector with first slurry to obtain an electrode plate with the current collector coated with a first slurry layer; and
rolling the electrode plate,
wherein the first slurry comprises first active substance particles, the first active substance particles comprise an equivalent sphericity X₁ as represented by the following Formula (1):
$${X}_{1} = 3 / ( {S}_{1} {R}_{1} {ρ}_{1} ) , \qquad Formula ( 1 )$$
wherein 0.05≤X₁≤0.8, R₁ is a median radius of the first active substance particles in a unit of μm; S₁ is a surface area of the first active substance particles in a unit of m²/g; and ρ₁ is true density of the first active substance particles in a unit of g/cm³.

14. The method according to claim 13, wherein, based on the electrode plate being a positive electrode plate, 0.10≤X₁≤0.8; or based on the electrode plate being a negative electrode plate, 0.05≤X₁≤0.8.

15. The method according to claim 13, wherein the coating the current collector with the first slurry comprises:
coating the current collector with the first slurry and second slurry to obtain the electrode plate sequentially coated with the first slurry layer and the second slurry layer in a direction far away from the current collector,
wherein the second slurry comprises second active substance particles, and the second active substance particles comprise an equivalent sphericity X₂ as represented by the following Formula (2):
$${X}_{2} = 3 / ( {S}_{2} {R}_{2} {ρ}_{2} ) , \qquad Formula ( 2 )$$
wherein R₂ is a median radius of the second active substance particles in the unit of μm; S₂ is a surface area of the second active substance particles in the unit of m²/g; ρ₂ is true density of the second active substance particles in the unit of g/cm³; and the equivalent sphericity X₂ of the second active substance particles is greater than the equivalent sphericity X₁ of the first active substance particles.

16. A secondary battery, comprising a secondary battery electrode plate that comprises:
a current collector; and
a first active material layer, located on a surface of the current collector, wherein the first active material layer comprises first active substance particles, and wherein the first active substance particles comprise an equivalent sphericity X₁ as represented by the following Formula (1):
$${X}_{1} = 3 / ( {S}_{1} {R}_{1} {ρ}_{1} ) , \qquad Formula ( 1 )$$
wherein 0.05≤X₁≤0.8, R₁ is a median radius of the first active substance particles in a unit of μm; S₁ is a surface area of the first active substance particles in a unit of m²/g; and ρ₁ is true density of the first active substance particles in a unit of g/cm³.

17. The secondary battery according to claim 16, wherein, based on the secondary battery electrode plate being a positive secondary battery electrode plate, 0.10≤X₁≤0.8; or based on the secondary battery electrode plate being a negative secondary battery electrode plate, 0.05≤X₁≤0.8.

18. The secondary battery according to claim 16, wherein the secondary battery electrode plate further comprises a second active material layer, wherein the second active material layer is located on a surface, deviating from the surface of the current collector, of the first active material layer, the second active material layer comprises second active substance particles, and wherein the second active substance particles comprise an equivalent sphericity X₂ as represented by the following Formula (2):
$${X}_{2} = 3 / ( {S}_{2} {R}_{2} {ρ}_{2} ) , \qquad Formula ( 2 )$$
wherein R₂ is a median radius of the second active substance particles in the unit of μm; S₂ is a surface area of the second active substance particles in the unit of m²/g; ρ₂ is true density of the second active substance particles in the unit of g/cm³; and the equivalent sphericity X₂ of the second active substance particles is greater than the equivalent sphericity X₁ of the first active substance particles.

19. The secondary battery according to claim 18, wherein 0.05≤X₁≤0.4; and 0.2≤X₂≤0.8.

20. The secondary battery according to claim 18, wherein 0.07≤X₂−X₁≤0.5.
